(19) United States
(12) Patent Application Publication
(10) Pub. No.: US 2026/0300315 A1
(43) Pub. Date: Oct. 1, 2026

(54) METHODS AND SYSTEMS TO SELECTIVELY SYNCHRONIZE LOCAL DATA AND REMOTE DATA USING PATCH COLLECTIONS

(71) Applicant: Lucid Software, Inc., South Jordan, UT (US)

(72) Inventors: Tyler Davis, South Jordan, UT (US); Joseph Stack, South Jordan, UT (US); James Hart, South Jordan, UT (US); Sheyne Anderson, South Jordan, UT (US); Houston Trueblood, South Jordan, UT (US)

(21) Appl. No.: 19/631,955

(22) Filed: Mar. 27, 2026

Related U.S. Application Data
(60) Provisional application No. 63/781,927, filed on Apr. 1, 2025.

(51) Int. Cl. G06F 16/27

(52) U.S. Cl. CPC G06F 16/27

(57) ABSTRACT

A method may include receiving data indicating associations between elements of information. The method may include generating local data based on the data. The local data may indicate the associations. The local data may be configured to synchronize with a copy of the data. The method may include displaying a graphical object including content. The method may include suspending synchronization between the local data and the copy of the data. The method may include modifying the content of the graphical object and generating a collection representative of the modifications to the content of the graphical object. The method may include resuming synchronization between the local data and the copy of the data. The method may include, responsive to the synchronization being resumed, updating the local data based on the collection and providing the patch collection to the third party data source to update the copy of the data.

### CROSS-REFERENCE TO RELATED APPLICATION

This patent application claims the benefit of and priority to U.S. Provisional App. No. 63/781,927 filed Apr. 1, 2025 titled “METHODS AND SYSTEM TO SELECTIVELY SYNCHRONIZE LOCAL DATA AND REMOTE DATA USING PATCH COLLECTIONS,” which is incorporated in the present disclosure by reference in its entirety.

### FIELD

The embodiments discussed in the present disclosure are related to methods and systems to selectively synchronize local data and remote data using patch collections.

### BACKGROUND

Unless otherwise indicated in the present disclosure, the materials described in the present disclosure are not prior art to the claims in the present application and are not admitted to be prior art by inclusion in this section.

A diagram application may receive source data representative of structured information (e.g., representative of networks, organizations, processes, or other structured items) from a third party data source. The diagram application may generate local data based on the source data. In addition, the diagram application may generate a graphical diagram or other visualization (generally referred to in the present disclosure as visualization) based on the local data. For example, the diagram application may generate the visualization as a network diagram, an organization chart, a flow diagram, or any other appropriate type of visualization.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a method may include receiving source data from a third party data source. The source data may indicate associations between elements of information. The method may also include generating local data based on the source data. The local data may indicate the associations between the elements of information. The local data may be configured to synchronize with a copy of the source data stored by the third party data source. In addition, the method may include displaying a graphical object. The graphical object may include content arranged in accordance with the local data. Further, the method may include suspending synchronization between the local data and the copy of the source data stored by the third party data source. The method may include modifying a portion of the content of the graphical object. The method may also include generating a patch collection representative of the modifications to the portion of the content of the graphical object. In addition, the method may include resuming synchronization between the local data and the copy of the source data stored by the third party data source. The method may include, responsive to the synchronization being resumed, updating the local data based on the patch collection. The method may also include, responsive to the synchronization being resumed, providing the patch collection to the third party data source so that the third party data source updates the copy of the source data to reflect the modifications to the portion of the content of the graphical object.

In another example embodiment, a method may include receiving source data from a third party data source. The source data may indicate associations between elements of information. The method may also include generating local data based on the source data. The local data may indicate the associations between the elements of information. In addition, the method may include displaying a first graphical object within a digital canvas. The first graphical object may include content arranged in accordance with the local data. Further, the method may include displaying a second graphical object within the digital canvas. The second graphical object may include content arranged in accordance with the local data. The method may include modifying a portion of the content of the second graphical object. The method may also include generating a patch collection representative of the modifications to the portion of the content of the second graphical object. In addition, the method may include updating the first graphical object based on the patch collection.

In another example embodiment, a method may include receiving source data from a third party data source. The source data may indicate associations between elements of information. The method may also include generating local data based on the source data. The local data may indicate the associations between the elements of information and the local data being configured to synchronize with a copy of the source data stored by the third party data source. In addition, the method may include displaying a first graphical object. The first graphical object may include content arranged in accordance with the local data. Further, the method may include suspending synchronization between the local data and the copy of the source data stored by the third party data source. The method may include displaying a second graphical object. The second graphical object may include content arranged in accordance with the local data. The method may also include modifying a portion of the content of the second graphical object. In addition, the method may include generating a patch collection representative of the modifications to the portion of the content of the second graphical object. Further, the method may include resuming synchronization between the local data and the copy of the source data stored by the third party data source. The method may include, responsive to the synchronization being resumed, updating the local data based on the patch collection. The method may also include, responsive to the synchronization being resumed, updating the first graphical object based on the patch collection. In addition, the method may include, responsive to the synchronization being resumed, providing the patch collection to the third party data so that the third party data source updates the copy of the source data to reflect the modifications to the portion of the content of the branch graphical object.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of an example operational environment for a computing device to generate a visualization based on source data;

FIG. 2 illustrates a process diagram to generate and update graphical objects in the visualization of FIG. 1;

FIGS. 3A and 3B illustrate an example of the digital location of FIG. 1 with the visualization including two graphical objects;

FIG. 4 illustrates an example of the digital location of FIG. 1 with the visualization including three graphical objects;

FIG. 5 illustrates a flowchart of an example method to suspend and resume synchronization between a visualization and source data;

FIG. 6 illustrates a flowchart of an example method to update a graphical object based on a patch collection;

FIGS. 7A and 7B illustrate a flowchart of an example method to suspend and resume synchronization between a visualization and source data and to update a graphical object based on a patch collection;

FIG. 8 is a block diagram illustrating an example computing device that is arranged to facilitate generation of multiple visual representations based on source data,

all according to at least one embodiment described in the present disclosure.

### DETAILED DESCRIPTION

The source data may indicate associations or relationships between elements of information. For example, the source data may indicate an association between an employee and their supervisor. As another example, the source data may indicate associations between portions of a flow (e.g., a start and an end) of a process. In some embodiments, the source data may be in a spreadsheet format, a task based format, a separated value format, or any other appropriate format. The diagram application may generate the local data as a locally stored representation of the source data (e.g., a copy or other related version of the source data). The local data may also indicate the associations between the elements of information.

The diagram application may generate the visualization within a digital location, a webpage, or any other appropriate digital location (generally referred to in the present disclosure as digital location). The diagram application may generate the visualization to visually indicate the associations between the elements of information. For example, the visualization may include an organization chart that visually indicates the association between the employee and their supervisor. As another example, the visualization may include a flow diagram that visually indicates the flow of the process represented in the source data. The visualization may include graphical objects (e.g., cards, tickets, boxes, illustrations, or any other appropriate graphical object) that display content that is arranged in accordance with the local data. For example, the content may include a name, title, location, or other appropriate information of the employee and/or their supervisor arranged in accordance with the local data.

When modifications are made to the visualization, the diagram application may store information representative of the modifications as a patch collection. For example, the content of one or more graphical objects may be modified and the diagram application may generate the patch collection representative of the modifications to the content of the one or more graphical objects. The diagram application may update the local data (e.g., the stored collection) based on the patch collection.

Some diagram applications may synchronize the visualization with the local data such that the local data is updated each time a modification is made to the visualization. Additionally or alternatively, some diagram applications may synchronize the visualization such that other portions of the visualization are updated each time a modification is made to a different portion of the visualization. For example, these diagram applications may update the content of a second graphical object each time a modification is made to the content of a first graphical object or vice versa.

Some diagram applications may synchronize the local data with a copy of the source data stored by the third party data source (generally referred to in the present disclosure as the stored source data) such that these diagram applications cause the third party data source to update the stored source data each time a modification is made to the visualization, the local data, or both. Additionally or alternatively, these diagram applications may synchronize the local data with the stored source data such that modifications to the stored source data are automatically propagated to the local data, the visualization, or both.

Some modifications to the visualization may be made to create and show different scenarios for the visualization within the digital location. For example, modifications may be made to create and show different scenarios in which the employee is associated with a first supervisor and separately with a second supervisor within the digital location. The different scenarios may include alternative routes, pathways, or outcomes; possible sequences of events, courses of action, or routes; or other possible outcomes, results, or conclusions for the elements of the local data.

However, if the local data, the stored source data, or the visualization are updated each time the visualization or the stored source data are modified, these diagram applications cannot create nor show the different scenarios for the visualization within a single digital location. For example, these diagram applications will not be able to create and show the different scenarios discussed above within a single digital location because each time the associated supervisor is changed in one scenario (e.g., in one graphical object of the visualization), the associated supervisor will be changed to match in the other scenarios (e.g., another graphical object of the visualization). Accordingly, these diagram applications may not permit the visualization to show different scenarios within a single digital location because the modifications will be propagated to the stored source data, the local data, or other graphical objects of the visualization.

The present disclosure provides techniques and systems to permit the visualization to show different scenarios within a single digital location. Some embodiments of the present disclosure may include a computing device that is configured to selectively suspend synchronization between the visualization, the local data, the stored source data, or some combination thereof. Accordingly, the modifications may be selectively propagated to the stored source data, the local data, or the other graphical objects of the visualization. In addition, in some embodiments, the computing device may be configured to create patch collections representative of modifications to branches of or scenarios for the visualization to permit different scenarios to be created and shown within a single digital location.

The computing device may receive the source data from the third party data source. The computing device may generate the local data based on the source data. In some embodiments, the local data may be configured to synchronize with the stored source data. The computing device may display the visualization including a first graphical object or a second graphical object within the digital location. In some embodiments, the second graphical object may include a branch graphical object that is a copy or other related version of the first graphical object. In these and other embodiments, the computing device may suspend synchronization between the local data, the visualization, the stored source data, or some combination thereof.

The computing device may modify the visualization. In some embodiments, the computing device may modify a portion of the content of the first graphical object. For example, the computing device may receive user input effective to add, remove, or change information displayed in the first graphical object.

The computing device may generate the patch collection representative of the modifications to the visualization. The patch collection may be representative of the modifications to the first graphical object, the modifications to the second graphical object, or any other appropriate modification to the visualization. The computing device may resume synchronization between the local data, the visualization, or the stored source data.

In some embodiments, responsive to the synchronization being resumed, the computing device may update the local data based on the patch collection. In these and other embodiments, responsive to the synchronization being resumed, the computing device may update the first graphical object, the second graphical object, or both based on the patch collection (e.g., update the visualization). In some embodiments, responsive to the synchronization being resumed, the computing device may provide the patch collection to the third party data source so that the third party data source updates the stored source data to reflect the modifications to the visualization. Additionally or alternatively, responsive to the synchronization being resumed, the computing device may provide the updated local data to the third party data source so that the third party data source updates the stored source data to reflect the modifications to the visualization.

The computing device and methods described in the present disclosure can selectively suspend synchronization between the visualization, the stored source data, or the local data. Accordingly, the computing device and methods described in the present disclosure permit different scenarios for the visualization to be shown within a single digital location. In other words, the computing device and methods described in the present disclosure permit multiple scenarios stemming from the same local data, the same source data, or both to be shown and modified individually within a single digital location. Accordingly, the computing device and methods described in the present disclosure provide improvements over other diagram applications that generate the visualization based on the source data without suspending synchronization.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

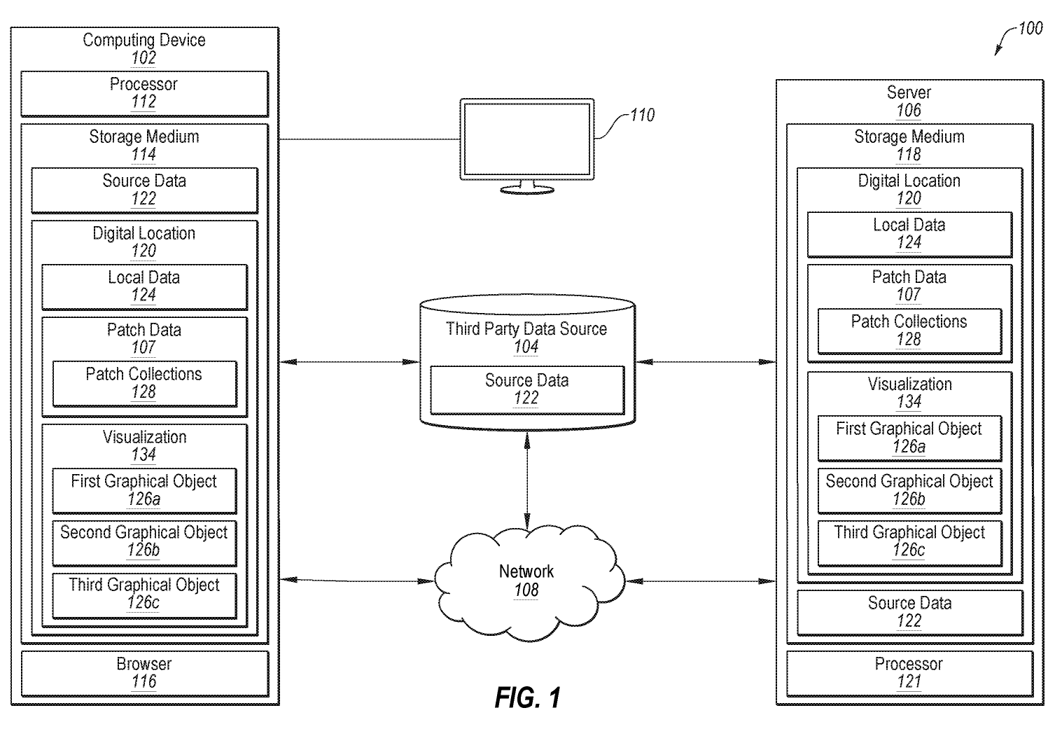

FIG. 1 illustrates a block diagram of an example operational environment 100 for a computing device 102 to generate a visualization 134 based on source data 122, arranged in accordance with at least one embodiment described herein. The computing device 102 may selectively suspend synchronization between local data 124, the source data 122, or the visualization 134. Additionally, the computing device 102 may create the visualization 134 including multiple scenarios within a single digital location 120 as described in more detail below. As shown in FIG. 1, the environment 100 includes the computing device 102, a network 108, a third party data source 104, and a server 106.

The computing device 102 may include a desktop computer, a laptop computer, a tablet computer, a mobile phone, a smartphone, a personal digital assistant (PDA), a wearable device (e.g., a smart watch), an interactive whiteboard (e.g., SURFACE HUB) or another suitable client device. The computing device 102 may include a processor 112, storage medium 114, or both that hosts the digital location 120 (e.g., a digital canvas, a webpage, or any other appropriate digital location) to allow the computing device 102 to generate the local data 124, the visualization 134, or both. Additionally, the digital location 120 may allow the computing device 102 to reflect modifications made to the visualization 134 as patch data 107 including patch collections 128. For example, the digital location 120 may allow the computing device 102 to reflect modifications made to the visualization 134 to the local data 124, the source data 122, or both or vice versa using the patch collections 128. In some embodiments, the patch collections 128 may store the modifications as tables of patches on top of the patch data 107, the local data 124, or both.

The server 106 may be a computer system that provides services to the computing device 102 over the network 108. The server 106 may include hardware components such as processor 121 and storage medium 118 that host the digital location 120 to allow the server 106 to generate the local data 124, the visualization 134, or both. Additionally, the digital location 120 may allow the server 106 to reflect modifications made to the visualization 134 as the patch data 107 including the patch collections 128. For example, the digital location 120 may allow the server 106 to reflect modifications made to the visualization 134 to the local data 124, the source data 122, or both or vice versa using the patch collections 128.

The processors 112 or 121 may be of any type such as a central processing unit (CPU), a microprocessor (µP), a microcontroller (µC), a digital signal processor (DSP), or any combination thereof. The processors 112 or 121 may be configured to execute computer instructions that, when executed, cause the processors 112 or 121 to perform or control performance of one or more of the operations described herein with respect to the computing device 102 or the server 106.

The storage mediums 114 or 118 may include any non-transitory computer-readable medium, including volatile memory such as RAM, persistent or non-volatile storage such as ROM, EEPROM, CD-ROM or other optical disk storage, magnetic disk storage or other magnetic storage device, NAND flash memory or other solid state storage device, or other persistent or non-volatile computer storage medium. The storage mediums 114 or 118 may store computer instructions that may be executed by the processors 112 or 121 to perform or control performance of one or more of the operations described herein with respect to the computing device 102 or the server 106.

The storage mediums 114 or 118 may additionally store the source data 122, the local data 124, the patch data 107, or some combination thereof temporarily or permanently. For example, the storage mediums 114 or 118 may temporarily store the source data 122 to generate the local data 124. The source data 122 may be imported from the server 106, the third party data source 104, or the computing device 102. The source data 122 may be imported over the network 108 or directly from the third party data source 104, the server 106, or the computing device 102 if a direct connection exists.

The computing device 102 may execute an application, such as a browser 116, configured to communicate through the network 108 with the server 106, the third party data source 104, or both. The browser 116 may include an Internet browser or other suitable application to communicate through the network 108 with the server 106, the third party data source 104, or both. The browser 116 may generate, download and/or interact with the digital location 120, the source data 122, the local data 124, and/or the visualization 134. In some embodiments, the computing device 102 may display the browser 116 including the digital location 120, the visualization 134, or both via a display 110.

Embodiments described herein are not limited to using the browser 116 to communicate with the server 106 or the third party data source 104 to generate the local data 124, the visualization 134, or both. For example, rather than or in addition to the browser 116, the computing device 102 may include a native app as are often used on computing devices such as mobile devices including smartphones, tablet computers, and interactive whiteboards. Accordingly, embodiments described herein generally include generating the local data 124, the visualization 134, or both using a browser, a native app, or another suitable application on the computing device 102.

In general, the network 108 may include one or more wide area networks (WANs) and/or local area networks (LANs) that enable the server 106, the computing device 102, and the third party data source 104 to communicate with each other. In some embodiments, the network 108 may include the Internet, including a global internetwork formed by logical and physical connections between multiple WANs and/or LANs. Alternately or additionally, the network 108 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 108 may also include servers that enable one type of network to interface with another type of network.

The third party data source 104 may include any memory or data storage. The third party data source 104 may include network communication capabilities such that other components in the environment 100 may communicate with the third party data source 104. In some embodiments, the third party data source 104 may include computer-readable storage media for carrying or having computer-executable instructions or data structures stored thereon. The computer-readable storage media may include any available media that may be accessed by a general-purpose or special-purpose computer, such as a processor. For example, the third party data source 104 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the third party data source 104.

In some embodiments, the server 106 and/or the computing device 102 may allow users to generate the local data 124 and/or the visualization 134 within the digital location 120 based on the source data 122 via the processor 121 of the server 106, the processor 112 of the computing device 102, or both. The visualization 134 (e.g., graphical diagram) may include a first graphical object 126a, a second graphical object 126b, or a third graphical object 126c representative of information in the local data 124.

The digital location 120 as used herein may refer to a document or other file that includes the visualization 134 including one or more graphical objects formatted and/or grouped by a user on a graphical drawing canvas. Alternatively or additionally, the digital location 120 may include data collections and/or pointers to data collections used to generate, format, or group graphical objects. As an example, the digital location 120 may include a virtual whiteboard application, for example, LUCIDSPARK, MURAL, MIRO, CONCEPTBOARD, ZITEBOARD, MICROSOFT WHITEBOARD, or other virtual whiteboard application.

Although one computing device 102, one server 106, and one third party data source 104 are illustrated in FIG. 1, the environment 100 may more generally include one or more servers 106, one or more computing devices 102, or one or more third party data sources 104. In these and other embodiments, the environment 100 may include other servers and/or devices not illustrated in FIG. 1.

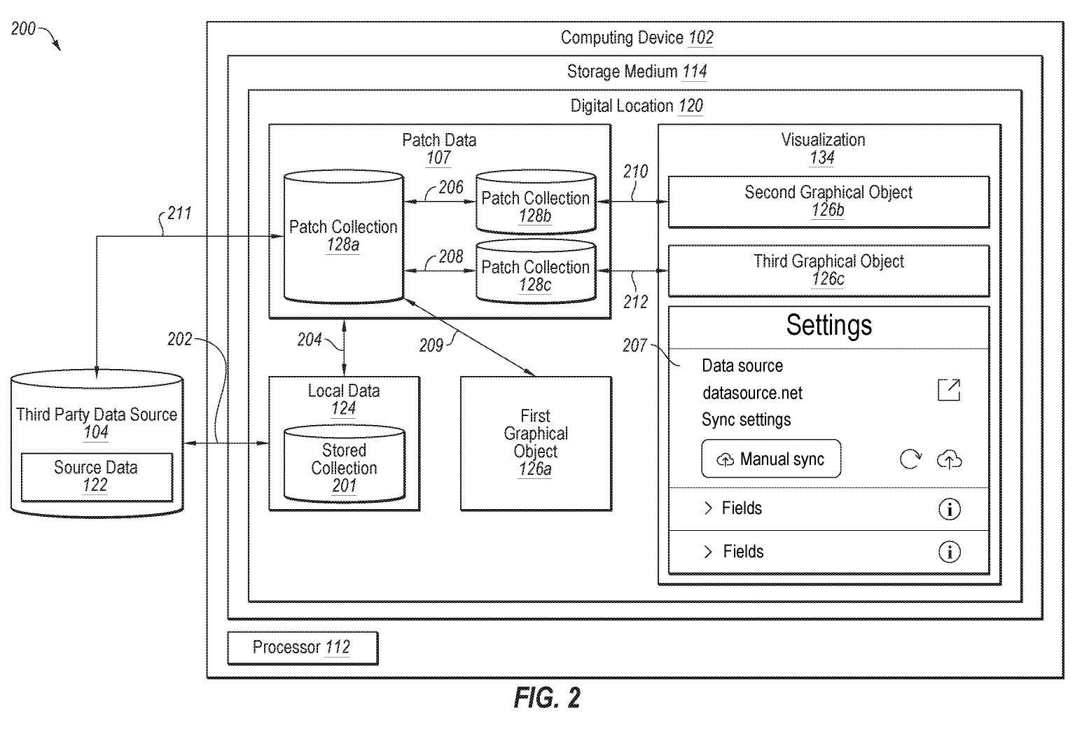

FIG. 2 illustrates a process diagram 200 to generate and update the graphical objects 126a-c in the visualization 134 of FIG. 1, arranged in accordance with at least one embodiment described herein. Aspects described as being performed by the processor 112 of the computing device 102 may be performed by the processor 121 of the server 106 and vice versa. For ease of discussion, the following discussion describes the processor 112 of the computing device 102 as performing the various aspects. However, these aspects may be performed by the processor 121 of the server 106 in addition to or instead of the processor 112.

With combined reference to FIGS. 1 and 2, the processor 112 may receive the source data 122 (represented by arrow 202 in FIG. 2) from the third party data source 104, the server 106, or both. The source data 122 may represent various types of information and associations between elements of that information. For example, the source data 122 may include information about employees, departments, roles, and/or reporting structures, and the source data 122 may indicate hierarchical relationships within the organization. As another example, the source data 122 may include information about a software development lifecycle, components of a technical architecture, or stages in a manufacturing process.

The source data 122 may include any data or information in which there are inherent relationship between different elements of the data or information. In addition, the source data 122 may include a structured representation of the information indicating how different elements of the information are related or associated. For example, the source data 122 may indicate a parent-child relationship, a dependency, a link between elements of the information, or any other appropriate type of relationship or association.

The processor 112 may generate the local data 124 based on the source data 122. The processor 112 may generate the local data 124 as a locally stored representation of the source data 122. In some embodiments, the processor 112 may generate the local data 124 as a copy or other related version of the source data 122. In these and other embodiments, the source data 122 may only be stored temporarily in the storage medium 114 and may be deleted or otherwise removed when the local data 124 is generated. The local data 124 may indicate the same or similar associations between elements of the information as the source data 122. In some embodiments, the local data 124 may be configured to synchronize with the source data 122 stored by the third party data source 104 (e.g., the copy of the source data 122 or the stored source data 122).

In some embodiments, the processor 112 may suspend synchronization between the local data 124, the visualization 134, or the source data 122 stored by the third party data source 104. In some embodiments, the processor 112 may suspend synchronization for only a portion of the visualization 134, a portion of the local data 124, or all the visualization 134 and the local data 124. For example, the processor 112 may suspend synchronization for a particular branch or scenario of the visualization 134 (e.g., the first graphical object 126a), while permitting synchronization for a different branch or scenario of the visualization 134 (e.g., the second graphical object 126b or the third graphical object 126c).

The processor 112 may suspend the synchronization by preventing the local data 124 from being updated based on modifications to the source data 122 (e.g., suspended pull synchronization), preventing the local data 124 (e.g., a stored collection 201 of the local data 124) from being provided to the third party data source 104 to update the source data 122 (e.g., a suspended push synchronization), preventing a patch collection 128a from being provided to the third party data source 104 to update the source data 122 (e.g., a suspended push synchronization), or some combination thereof. Additionally or alternatively, the processor 112 may suspend synchronization by preventing the local data 124 from being updated based on the patch collections 128a-c (e.g., a suspended local pull synchronization), preventing the visualization 134 from being updated based on changes to the local data 124 (e.g., a suspended local push synchronization), preventing other graphical objects from being updated based on the patch collections 128a-c (e.g., a suspended local push synchronization or a suspended local pull synchronization), or some combination thereof.

In some embodiments, the processor 112 may suspend the synchronization in response to receiving user input indicating synchronization should be paused. The user input may be received via a selection menu 207 displayed within the digital location 120. The selection menu 207 may include various fields, buttons, or other selection options corresponding to the different types of suspended synchronization such as suspended pull, suspended push, suspended local pull, suspended local push, or some combination thereof. The processor 112 may maintain the suspended synchronization until receiving input to resume the synchronization. This may allow a user to make modifications to the visualization 134 without those modifications being automatically reflected in the local data 124, the visualization 134, or the source data 122. When the synchronization is resumed, the processor 112 may apply the accumulated modifications from the patch collections 128a-c, the stored collection 201, or both to update the local data 124, the source data 122, or both as appropriate.

Despite the processor 112 being described as suspending the synchronization after generating the local data 124 but before generating the graphical objects 126a-c, the processor 112 may suspend the synchronization at any appropriate point in time. For example, the processor 112 may suspend the synchronization before the local data 124 is generated, after the patch collection 128a is generated, after the graphical objects 126a-b are generated, or any other appropriate time.

As described in more detail below, the processor 112 may generate the patch data 107 based on modifications to the visualization 134, the source data 122, the local data 124, or some combination thereof. The patch data 107 may include the patch collections 128a-c representative of modifications to the visualization 134, the local data 124, or the source data 122. The processor 112 may store the patch collections 128a-c as part of the patch data 107. Each of the patch collections 128a-c may represent a set of modifications made to corresponding portions of the visualization 134, the local data 124, or the source data 122. In some embodiments, the patch collections 128a-c may include patches on top of corresponding portions of the local data 124.

The patch collections 128a-c may capture corresponding modifications that are made to the visualization 134 or to the corresponding portions of the local data 124 or the source data 122 to allow different scenarios for the visualization 134 to be developed. For example, the patch collection 128a may capture modifications to the first graphical object 126a or modifications to corresponding portions of the local data 124 or the source data 122 as a first scenario for the visualization 134. As another example, the patch collection 128b may capture modifications to the second graphical object 126b or modifications to corresponding portions of the local data 124 or the source data 122 as a second scenario for the visualization 134. As another example, the patch collection 128c may capture modifications to the third graphical object 126c or modifications to corresponding portions of the local data 124 or the source data 122 as a third scenario for the visualization 134. In some embodiments, the patch collection 128a may aggregate the patch collections 128b or 128c (e.g., modifications from the second branch or the third branch of the visualization 134) or corresponding portions of the local data 124 or the source data 122.

While the synchronization is suspended, the processor 112 may not propagate the modifications made to the graphical objects 126a-c to the local data 124, or the source data 122. Additionally or alternatively, while the synchronization is suspended, the processor 112 may not propagate the modifications made to the source data 122 and/or the local data 124 to the visualization 134. Accordingly, the processor 112 may permit the modifications to be made to the graphical objects 126a-c without also modifying the local data 124, the source data 122, or the other graphical objects 126a-c for at least a period of time.

As described in more detail below, the processor 112 may use the patch collections 128a-c to update the visualization 134, the local data 124, and/or the source data 122 when the synchronization is enabled. Additionally, the patch collections 128a-c may maintain records of the modification to the visualization 134 for use by the processor 112 as described in more detail below.

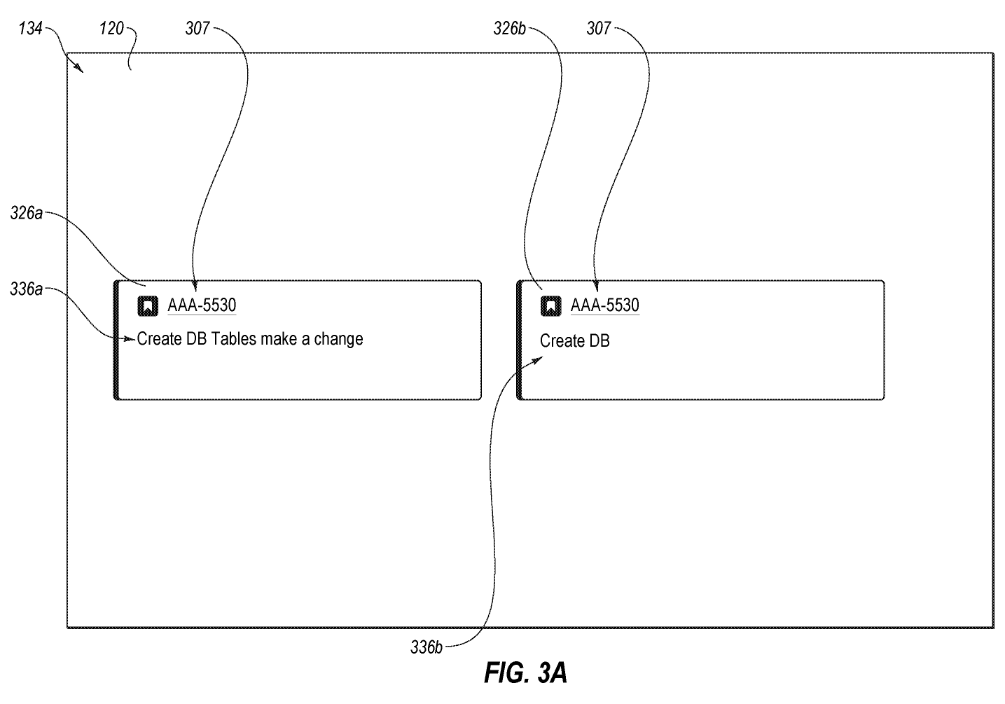

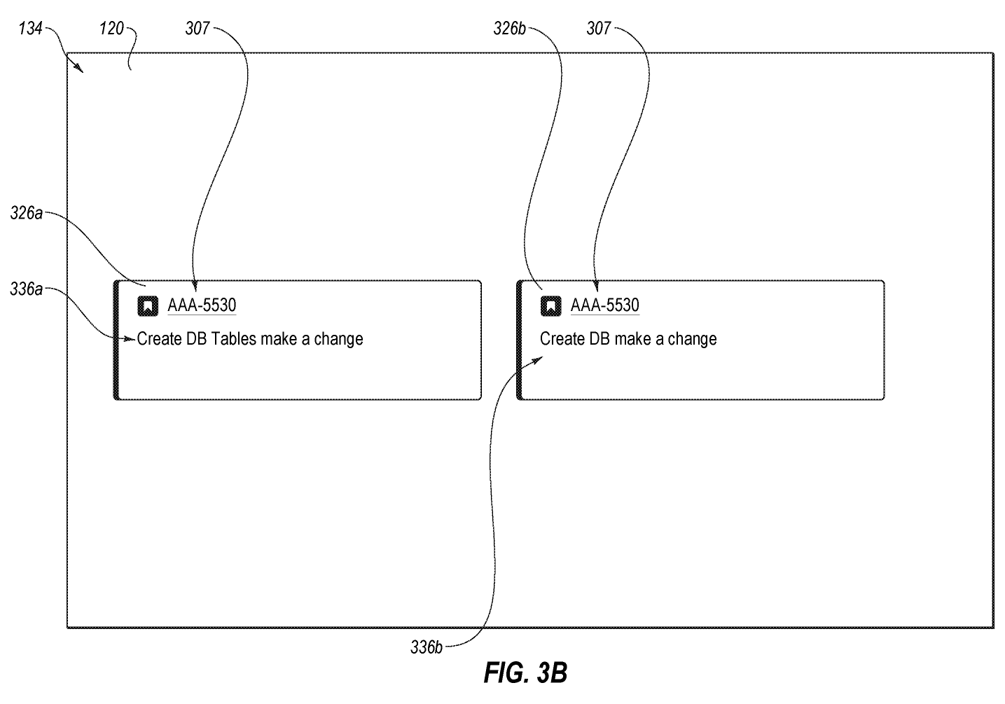

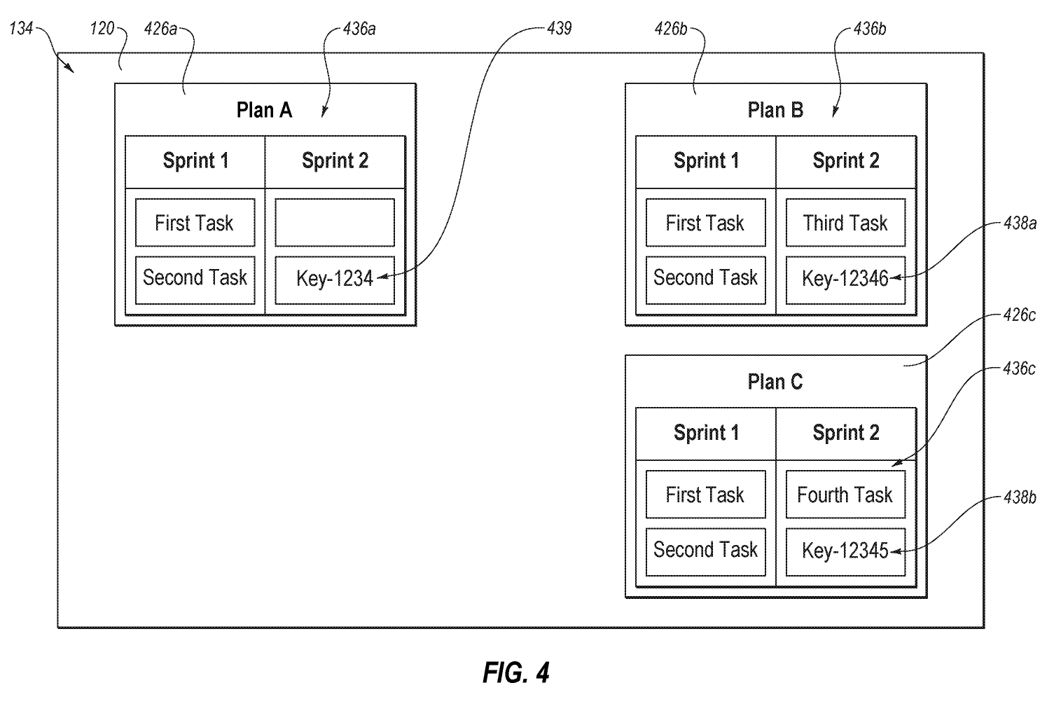

The processor 112 may generate the graphical objects 126a-c within the visualization 134. The graphical objects 126a-c may include content arranged in accordance with the local data 124, the patch data 107, or both. For example, the content of the graphical objects 126a-c may display information or indicate relationships between elements of information in accordance with the information and the associations indicated in the local data 124 or modifications represented in the patch collections 128a-c. Example graphical objects and content are described in more detail in relation to FIGS. 3A-4.

An example of the content of the first graphical object 126a being modified will now be discussed. The processor 112 may modify a portion of the content of the first graphical object 126a. In some embodiments, the processor 112 may modify the content of the first graphical object 126a based on user input, modifications to the local data 124, modifications to the source data 122, or other factors. For example, the processor 112 may add, remove, or change content such as text, images, shapes, or other visual elements displayed in the first graphical object 126a. As another example, the processor 112 may alter or update attributes of the first graphical object 126a such as its size, position, color, style, or other visual attributes. As yet another example, the processor 112 may alter or update relationships or connections between the elements of information of the content of the first graphical object 126a such as creating new links between elements of the information, removing links between elements of the information, or altering a nature of the links between elements of the information.

The processor 112 may generate or update (represented by arrow 209) the patch collection 128a to be representative of the modifications to the first graphical object 126a. For example, if text is added to the first graphical object 126a, the processor 112 may generate or update the patch collection 128a to include the new text content over the top of or identifying corresponding elements of the local data 124. Accordingly, the processor 112 may store the modifications to the first graphical object 126a locally as part of the patch data 107.

The processor 112 may resume the synchronization between the local data 124, the visualization 134, or the source data 122. In some embodiments, the processor 112 may resume the synchronization in response to receiving user input indicating the synchronization should be resumed. The user input may be received via the selection menu 207. The processor 112 may resume the synchronization to permit the modifications to the first graphical object 126a to be propagated (e.g., incorporated into) to the local data 124, the source data 122, or the other graphical objects 126b-c. Additionally or alternatively, the processor 112 may resume the synchronization between the local data 124, the visualization 134, or the source data 122 to permit modifications to the source data 122 stored by the third party data source 104 to be propagated to the local data 124, the visualization 134, or both.

When the synchronization is resumed, the processor 112 may use the patch collection 128a to update (represented by arrow 206) the patch collection 128b. The update to the patch collection 128b may cause (represented by arrow 210) the content of the second graphical object 126b to reflect the modifications to the first graphical object 126a. Additionally or alternatively, the processor 112 may use the patch collection 128a to update (represented by arrow 208) the patch collection 128c. The update to the patch collection 128c may cause (represented by arrow 212) the content of the third graphical object 126c to reflect the modifications to the first graphical object 126a.

The processor 112 may use the patch collection 128a to update (represented by arrow 204) the local data 124. The processor 112 may update the local data 124 using the patch collection 128a to alter the associations between the elements of the local data 124 to reflect the modifications to the graphical objects 126a-c. Additionally, the processor 112 may use the patch collection 128a to update the stored collection 201.

The processor 112 may provide (represented by arrow 211) the patch collection 128a to the third party data source 104. For example, the processor 112 may cause a message to be sent to the third party data source 104 indicating the modifications to the graphical object 126 (e.g., including the patch collection 128a). In some embodiments, the third party data source 104 may update the source data 122 based on the patch collection 128a. The source data 122 may be updated to reflect the modifications to the graphical objects 126a-c.

In some embodiments, the processor 112 may provide (represented by arrow 202) the stored collection 201, the local data 124, or both to the third party data source 104. For example, the processor 112 may cause a message to be sent to the third party data source 104 indicating the modifications to the graphical object 126 (e.g., including the stored collection 201). In some embodiments, the third party data source 104 may update the source data 122 based on the stored collection 201, the local data 124, or both. The source data 122 may be updated to reflect the modifications to the graphical objects 126a-c.

In some embodiments, the graphical objects 126b-c may include copies or other related versions of the first graphical object 126a. For example, the processor 112 may receive input effective to copy the first graphical object 126a as the second graphical object 126b. As another example, the processor 112 may receive input effective to import the source data 122 again and generate the third graphical object 126c based on the subsequent import.

As described in more detail below, each of the graphical objects 126a-c may include different reference keys. In some embodiments, the reference keys may indicate that the first graphical object 126a is associated with the local data 124 and that the second graphical object 126b and the third graphical object 126c are associated with (e.g., branch from) the first graphical object 126a. However, the different reference keys may provide individual identities for the second graphical object 126b and the third graphical object 126c. In other embodiments, the different reference keys may indicate that the third graphical object 126c is associated with (e.g., branches from) the second graphical object 126b, the second graphical object 126b is associated with (e.g., branches from) the first graphical object 126a, and the first graphical object 126 is associated with the local data 124.

Examples of the content of the second graphical object 126b and the third graphical object 126c being modified will now be discussed. The processor 112 may modify a portion of the content of one or both of the graphical objects 126b-c in the same or similar manner as described above in relation to the first graphical object 126a.

When the content of the second graphical object 126b is modified, the processor 112 may generate or update (represented by arrow 210) the patch collection 128b to be representative of the modifications to the second graphical object 126b. Accordingly, the processor 112 may store the modifications to the second graphical object 126b locally as part of the patch data 107. When the content of the third graphical object 126c is modified, the processor 112 may generate or update (represented by arrow 212) the patch collection 128c to be representative of the modifications to the third graphical object 126c. Accordingly, the processor 112 may store the modifications to the third graphical object 126c.

While the synchronization is suspended, the processor 112 may not propagate the modifications to the graphical objects 126b-c to the local data 124, the source data 122, or the first graphical object 126a. Accordingly, the processor 112 may permit modifications to be made to the graphical objects 126b-c without also modifying the local data 124, the source data 122, or the first graphical object 126a for at least a period of time.

In some embodiments, the processor 112 may resume the synchronization between the local data 124, the visualization 134, or the source data 122. The processor 112 may resume the synchronization to permit the modifications to the graphical objects 126b-c to be propagated (e.g., incorporated into) to the local data 124, the source data 122, or the first graphical object 126a. When the synchronization is resumed and the second graphical object 126b is modified, the processor 112 may use the patch collection 128b to update (represented by arrow 206) the patch collection 128a. When the synchronization is resumed and the third graphical object 126c is modified, the processor 112 may use the patch collection 128c to update (represented by arrow 208) the patch collection 128a. The update to the patch collection 128a may cause (represented by arrow 209) the content of the first graphical object 126a to reflect the modifications to the second graphical object 126b and/or the third graphical object 126c.

In some embodiments, the processor 112 may update the patch collection 128a to aggregate the modifications represented by the patch collections 128b-c. In some embodiments, the processor 112 may use the patch collection 128a to update (represented by arrows 206 and 208) the patch collections 128b-c. For example, if the content of the second graphical object 126b is modified, the processor 112 may use the patch collection 128a to update to the patch collection 128c to cause the content of the third graphical object 126c to reflect the modifications to the second graphical object 126b. As another example, if the content of the third graphical object 126c is modified, the processor may use the patch collection 128a to update the patch collection 128b to reflect the modifications to the third graphical object 126c.

In some embodiments, while the synchronization is suspended, the processor 112 may select one of the graphical objects 126a-c as an approved graphical object. For example, the processor 112 may receive user input effective to select the first graphical object 126a, the second graphical object 126b, or the third graphical object 126c as the approved graphical object. The approved graphical object may indicate that the corresponding scenario is selected as the scenario for the synchronization with the local data 124, the visualization 134, the source data 122, or some combination thereof.

In some embodiments, the processor 112 may use a visual indicator to distinguish the approved graphical object from other graphical objects. For example, the processor 112 may display a border, a highlight or other visual effect around the approved graphical object.

When the synchronization is resumed, the processor 112 may use the patch collection corresponding to the approved graphical object to update the other patch collections 128. For example, if the first graphical object 126a is selected as the approved graphical object, the processor 112 may use the patch collection 128a to update the patch collections 128b-c. Alternatively, if the second graphical object 126b is selected as the approved graphical object, the processor 112 may update the patch collection 128a using the patch collection 128b.

Additionally, in some embodiments, the processor 112 may use the patch collection 128a to update the patch collection 128 corresponding to the non-approved graphical object. For example, if the second graphical object 126b is selected as the approved graphical object, the processor 112 may use the patch collection 128a to update the patch collection 128c. As another example, if the third graphical object 126c is selected as the approved graphical object, the processor 112 may use the patch collection 128a to update the patch collection 128b.

In some embodiments, the processor 112 may convert the patch collection 128 corresponding to the non-approved graphical object to flat data. For example, if the first graphical object 126a is selected as the approved graphical object, the processor 112 may convert the patch collections 128b-c to the flat data. As another example, if the second graphical object 126b is selected as the approved graphical object, the processor 112 may convert the patch collections 128c to the flat data. The flat data may provide a historical record of the corresponding scenario for the visualization 134 for subsequent analysis or review.

The flat data may include a flattened representation of a corresponding patch collection 128, corresponding portions of the local data 124, or both. In addition, the processor 112 may remove branching or versioning information from the flat data (e.g., a link between the flat data and the local data 124, the source data 122, other patch collections 128, or some combination thereof is severed). In other words, the flat data may no longer be configured to synchronize with the local data 124, the source data 122, or both. To generate the flat data, the processor 112 may aggregate corresponding portions of the local data 124, the patch data 107 or both into separate data.

In some embodiments, if the synchronization is to resume, the processor 112 may determine if an approved graphical object has been selected. For example, the processor 112 may determine that none of the graphical objects 126a-c have been selected as the approved graphical object. If the processor 112 determines no approved graphical object has been selected, the processor 112 may display a notification (not shown) via the digital location 120. The notification may include a pop up notification, a menu, or other notification. The notification may instruct a user to select one of the graphical objects 126a-c as the approved graphical object. In some embodiments, the processor 112 may resume the synchronization in response to receiving the user input effective to select one of the graphical objects 126a-c as the approved graphical object.

In some embodiments, the graphical objects 126a-c, the visualization 134, or the digital location 120 may include a button to resume the synchronization. For example, the graphical objects 126a-c may include a button to resume synchronization between just the corresponding graphical object and the local data 124 or the source data 122. As another example, the graphical objects 126a-c may include a button to resume synchronization between the visualization 134 and the local data 124 or the source data 122. As another example, the visualization 134 may include a button to resume synchronization between the visualization and the local data 124 or the source data 122.

FIGS. 3A and 3B illustrate an example of the digital location 120 of FIG. 1 with the visualization including two graphical objects 326a-b, arranged in accordance with at least one embodiment described herein. The graphical object 326a includes content 336a arranged in accordance with the local data (e.g., the local data 124 of FIG. 1). Additionally, the graphical object 326b includes content 336b arranged in accordance with the local data. Further, the synchronization is enabled (e.g., not suspended) for the graphical objects 326a-b.

The graphical objects 326a-b include a reference key 307 including “AAA-5530,” which indicates that both of the graphical objects 326a-b are associated with the local data 124, the patch data 107, or both. Because the reference keys 307 are the same, the graphical objects 326a-b are linked to each other. Accordingly, because the synchronization is enabled, the modifications that are made to one of the graphical objects 326a-b are automatically propagated to the other graphical object 326a-b.

An example of modifying the content 336a of the graphical object 326a and propagating the modifications to the graphical object 326b will now be discussed. FIG. 3A illustrates the graphical objects 326a-b after a modification is made to the content 336a of the graphical object 326a but before the modifications are propagated to the graphical object 326b. The content 336a of the graphical object 326a was modified from “Create DB” to “Create DB Tables make a change.” The content 336b of the graphical object 326b includes the original information “Create DB.”

FIG. 3B illustrates the graphical objects 326a-b after the modifications to the graphical object 326a are propagated to the graphical object 326b. Because the graphical objects 326a-b are linked, the modifications to the content 336a of the graphical object 326a are propagated to the content 336b of the graphical object 326b as part of the synchronization. Accordingly, the content 336b of the graphical object 326b, as shown in FIG. 3B, has been updated to include “Create DB Tables make a change.”

In some embodiments, the graphical object 326b may be updated when the modifications to the content 336a of the graphical object 326a are finished. Accordingly, with the synchronization enabled, the graphical objects 326a-b of the visualization 134 will include the same content.

FIG. 4 illustrates an example of the digital location 120 of FIG. 1 with the visualization 134 including three graphical objects 426a-c, arranged in accordance with at least one embodiment described herein. For the description of FIG. 4, the synchronization is suspended such that modifications to content 436a-c of the graphical objects 426a-c are not automatically propagated.

The graphical objects 426a-c correspond to different scenarios for the visualization 134. For example, the first graphical object 426a includes a “Plan A” scenario, the second graphical object 426b includes a “Plan B” scenario, and the third graphical object 426c includes a “Plan C” scenario.

As shown in FIG. 4, the graphical objects 426a-c include containers and the content 436a-c includes multiple cards positioned within dynamic tables of the containers. For example, the content 436a-c of the graphical objects 426a-c include cards representing both a first task and a second task. However, the content 436b of the second graphical object 426b has been modified to also include a card representing a third task. In addition, the content 436c of the third graphical object 426b has been modified to also include a card representing a fourth task.

Accordingly, the first graphical object 426a corresponds to a scenario that only includes the first task and the second task. The second graphical object 426b corresponds to a scenario that includes the first task, the second task, and the third task. Further, the third graphical object 426c corresponds to a scenario that includes the first task, the second task, and the fourth task. In other words, each of the graphical objects 426a-c correspond to different scenarios.

The first graphical object 426a includes a reference key 439 including “Key-1234.” The reference key 439 may indicate that the first graphical object 426a is associated with the local data 124, the patch data 107, or both. The graphical objects 426b-c include reference keys 438a-b that are different from each other and different from the reference key 439. The reference key 438a of the second graphical object 426b includes “Key-12346” and the reference key 438b of the third graphical object 426c includes “Key-12345.”

Both of the reference keys 438a-b include “Key-1234” (e.g., a same root) and may indicate that the graphical objects 426b-c are associated with (e.g., branch from) the first graphical object 426a. However, both reference keys 438a-b include different end parts. For example, the reference key 438a of the second graphical object 426b ends with “6” and the reference key 438b of the third graphical object ends with “5.” The different ending numbers may indicate that the graphical objects 426b-c do not branch from or are not associated with each other.

Because the synchronization is suspended, modifications to the graphical objects 426a-c may not be automatically propagated. This allows independent modifications to be made to the graphical objects 426a-c. In particular, this allows the graphical objects 430b-c to include the third task or the fourth task as shown in FIG. 4. Patch collections representing the modifications to the graphical objects 426a-c may be generated as described in detail above. Additionally, when one or more of the graphical objects 426a-c are selected as the approved graphical object and/or the synchronization is resumed, the corresponding patch collections may be used to update the local data 124, the patch collections, or the source data 122 as described in detail above.

In some embodiments, when a card of the content 436a-c is positioned within a dynamic table of the graphical objects 426a-c, the card may automatically become associated with the corresponding scenario. For example, if an additional card (e.g., a card corresponding to a fifth task not shown in FIG. 4) is positioned in the dynamic table of the second graphical object 426b, the additional card (e.g., the fifth task) may automatically become associated with “Plan B.”

In some embodiments, the graphical objects 426a-c, the visualization 134, or the digital location 120 may include a button to resume the synchronization. In these and other embodiments, the button may cause the synchronization to occur for a single container (e.g., individual instances of the graphical objects 426a-c) to resume.

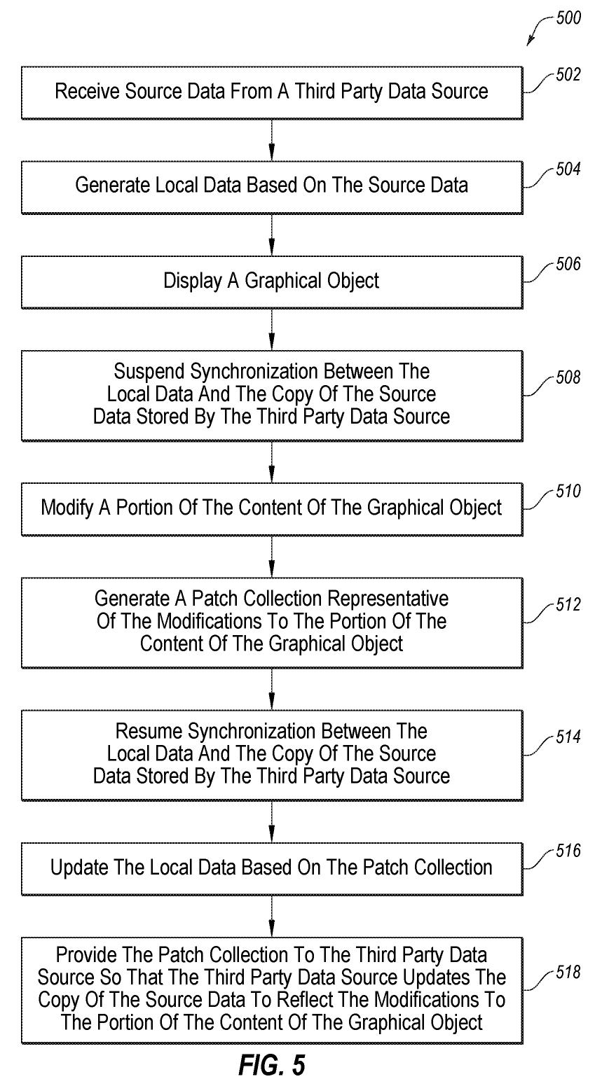

FIG. 5 illustrates a flowchart of an example method 500 to suspend and resume synchronization between a visualization and source data, in accordance with at least one embodiment described in the present disclosure. The method 500 may be performed by any suitable system, apparatus, or device with respect to generating graphical objects within a visualization. For example, the processors 112 and/or 121 of FIG. 1 may perform or direct performance of one or more of the operations associated with the method 500. The method 500 may include one or more blocks 502, 504, 506, 508, 510, 512, 514, 516, or 518. Although illustrated with discrete blocks, the steps and operations associated with one or more of the blocks of the method 500 may be divided into additional blocks, combined into fewer blocks, or eliminated, depending on the particular implementation.

At block 502, source data may be received from a third party data source. For example, the processor 112 may receive the source data 122 from the third party data source 104. The source data may indicate associations between elements of information. At block 504, local data may be generated based on the source data. For example, the processor 112 may generate and store the local data 124 based on the source data 122. The local data may indicate the associations between the elements of information. The local data may also be configured to synchronize with a copy of the source data stored by the third party data source.

At block 506, a graphical object may be displayed. The graphical object may include content arranged in accordance with the local data 124. For example, the processor 112 may cause the graphical object 126 to be displayed within the digital location 120. At block 508, synchronization between the local data and the source data stored by the third party data source may be suspended. For example, the processor 112 may suspend the push synchronization, pull synchronization, local push synchronization, or local pull synchronization.

At block 510, a portion of the content of the graphical object may be modified. For example, text may be added or deleted, a new graphical object may be generated, or aspects of the graphical object may be modified. At block 512, a patch collection representative of the modifications to the portion of the content of the graphical object may be generated. For example, the processor 112 may generate the patch collections 128 to be representative of the modifications to the graphical objects 126a-c.

At block 514, synchronization between the local data and the copy of the source data stored by the third party data source may resume. For example, the processor 112 may receive user input via the selection menu 207 as described above in more detail.

At block 516, responsive to the synchronization being resumed, the local data may be updated based on the patch collection. For example, the processor 112 may use the patch collection 128 to update the local data 124. At block 518, responsive to the synchronization being resumed, the patch collection may be provided to the third party data source so that the third party data sources updates the copy of the source data to reflect the modifications to the portion of the content of the graphical object. For example, the processor 112 may provide the stored collection 201 to the third party data source 104 to cause the third party data source 104 to update the source data 122.

Modifications, additions, or omissions may be made to the method 500 without departing from the scope of the present disclosure. For example, the operations of method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

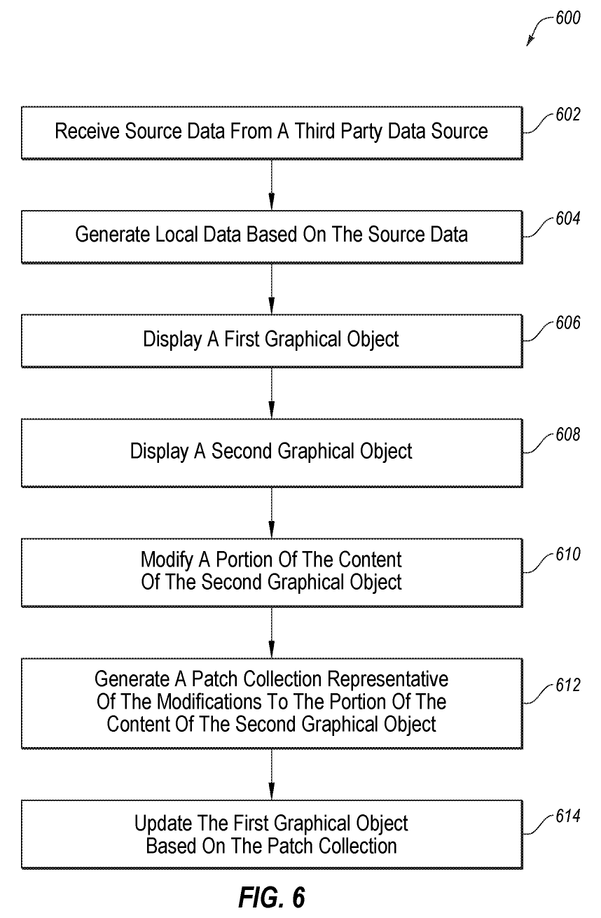

FIG. 6 illustrates a flowchart of an example method 600 to update a graphical object based on a patch collection, in accordance with at least one embodiment described in the present disclosure. The method 600 may be performed by any suitable system, apparatus, or device with respect to updating the graphical object based on the patch collection. For example, the processors 112 and/or 121 of FIG. 1 may perform or direct performance of one or more of the operations associated with the method 600. The method 600 may include one or more blocks 602, 604, 606, 608, 610, 612, or 614. Although illustrated with discrete blocks, the steps and operations associated with one or more of the blocks of the method 600 may be divided into additional blocks, combined into fewer blocks, or eliminated, depending on the particular implementation.

At block 602, source data may be received from a third party data source. For example, the processor 112 may receive the source data 122 from the third party data source 104. The source data may indicate associations between elements of information. At block 604, local data may be generated based on the source data. For example, the processor 112 may generate and store the local data 124 based on the source data 122. The local data may indicate the associations between the elements of information. The local data may also be configured to synchronize with a copy of the source data stored by the third party data source.

At block 606, a first graphical object may be displayed. The first graphical object may include content arranged in accordance with the local data 124. For example, the processor 112 may generate the first graphical object 126a. At block 608, a second graphical object may be displayed. The second graphical object may include content arranged in accordance with the local data. For example, the processor 112 may generate the second graphical object 126b in accordance with the local data 124.

At block 610, a portion of the content of the second graphical object may be modified. For example, text may be added or deleted, or aspects of the branch graphical object may be modified. At block 612, a patch collection representative of the modifications to the portion of the content of the second graphical object may be generated. For example, the processor 112 may generate the patch collections 128 to be representative of the modifications to the second graphical object 126b.

At block 614, the first graphical object may be updated based on the patch collection. For example, the processor 112 may use the patch collection 128 to update the first graphical object 126a to reflect the modifications to the branch graphical object.

Modifications, additions, or omissions may be made to the method 600 without departing from the scope of the present disclosure. For example, the operations of method 600 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

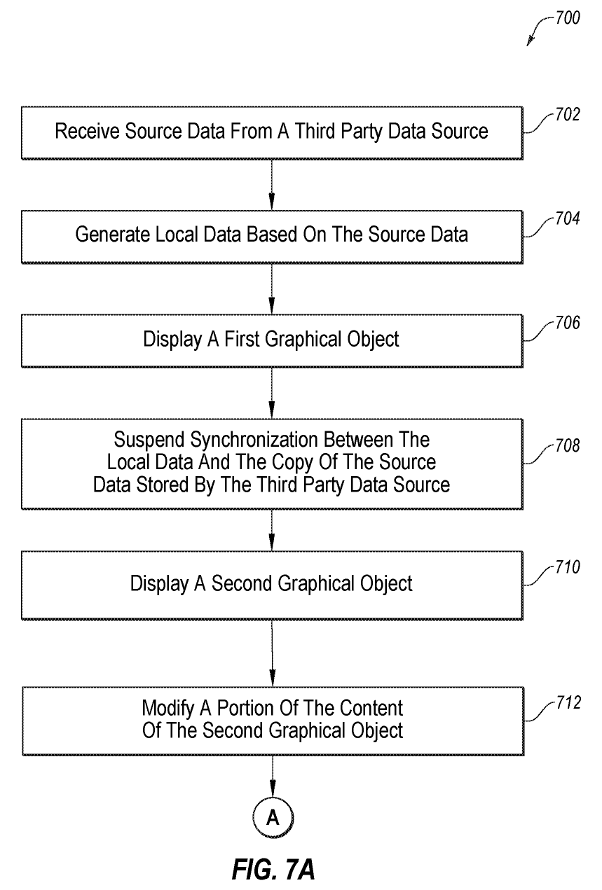

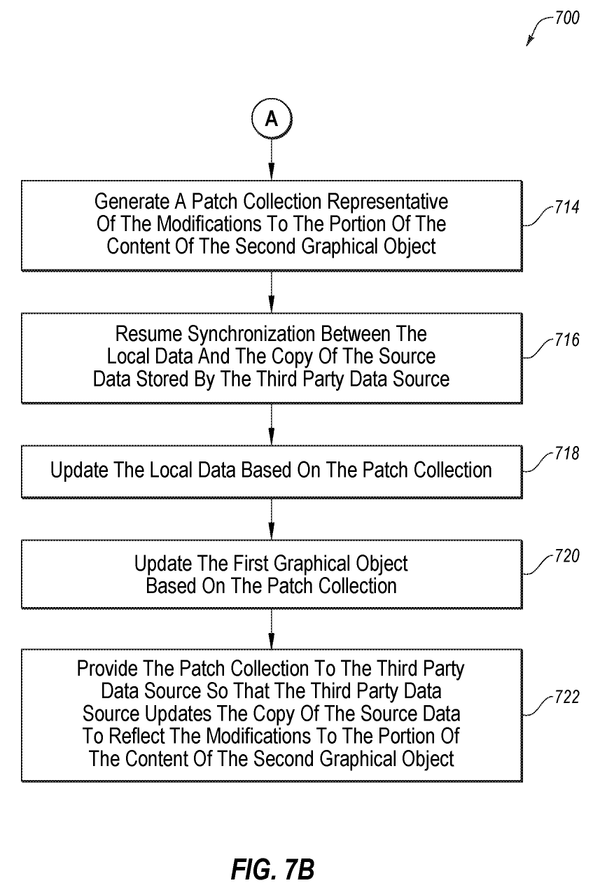

FIGS. 7A and 7B illustrate a flowchart of an example method 700 to suspend and resume synchronization between a visualization and source data and to update a graphical object based on a patch collection, in accordance with at least one embodiment described in the present disclosure. The method 700 may be performed by any suitable system, apparatus, or device with respect to suspending and resuming synchronization between the visualization and updating the graphical object based on the patch collection. For example, the processors 112 and/or 121 of FIG. 1 may perform or direct performance of one or more of the operations associated with the method 700. The method 700 may include one or more blocks 702, 704, 706, 708, 710, 712, 714, 716, 718, 720, or 722. Although illustrated with discrete blocks, the steps and operations associated with one or more of the blocks of the method 700 may be divided into additional blocks, combined into fewer blocks, or eliminated, depending on the particular implementation.

At block 702, source data may be received from a third party data source. For example, the processor 112 may receive the source data 122 from the third party data source 104. The source data may indicate associations between elements of information. At block 704, local data may be generated based on the source data. For example, the processor 112 may generate and store the local data 124 based on the source data 122. The local data may indicate the associations between the elements of information. The local data may also be configured to synchronize with a copy of the source data stored by the third party data source.

At block 706, a first graphical object may be displayed within a digital canvas. The first graphical object may include content arranged in accordance with the local data 124. For example, the processor 112 may cause the first graphical object 126a to be displayed. At block 708, synchronization between the local data and the source data stored by the third party data source may be suspended. For example, the processor 112 may suspend the push synchronization, pull synchronization, local push synchronization, or local pull synchronization.

At block 710, a second graphical object may be displayed. The second graphical object may include content arranged in accordance with the local data. For example, the processor 112 may generate the second graphical object 126b in accordance with the local data 124. At block 712, a portion of the content of the second graphical object may be modified. For example, text may be added or deleted or aspects of the second graphical object may be modified.

At block 714, a patch collection representative of the modifications to the portion of the content of the second graphical object may be generated. For example, the processor 112 may generate the patch collection 128b to be representative of the modifications to the second graphical object. At block 716, synchronization between the local data and the copy of the source data stored by the third party data source may resume. For example, the processor 112 may receive user input via the selection menu 207 as described above in more detail.

At block 718, responsive to the synchronization being resumed, the local data may be updated based on the patch collection. For example, the processor 112 may use the patch collection 128a to update the local data 124. At block 720, responsive to the synchronization being resumed, the first graphical object may be updated based on the patch collection. At block 722, responsive to the synchronization being resumed, the patch collection may be provided to the third party data source so that the third party data source updates the copy of the source data to reflect the modifications to the portion of the content of the branch graphical object. For example, the processor 112 may provide the patch collection 128a to the third party data source 104 to cause the third party data source 104 to update the source data 122.

Modifications, additions, or omissions may be made to the method 700 without departing from the scope of the present disclosure. For example, the operations of method 700 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

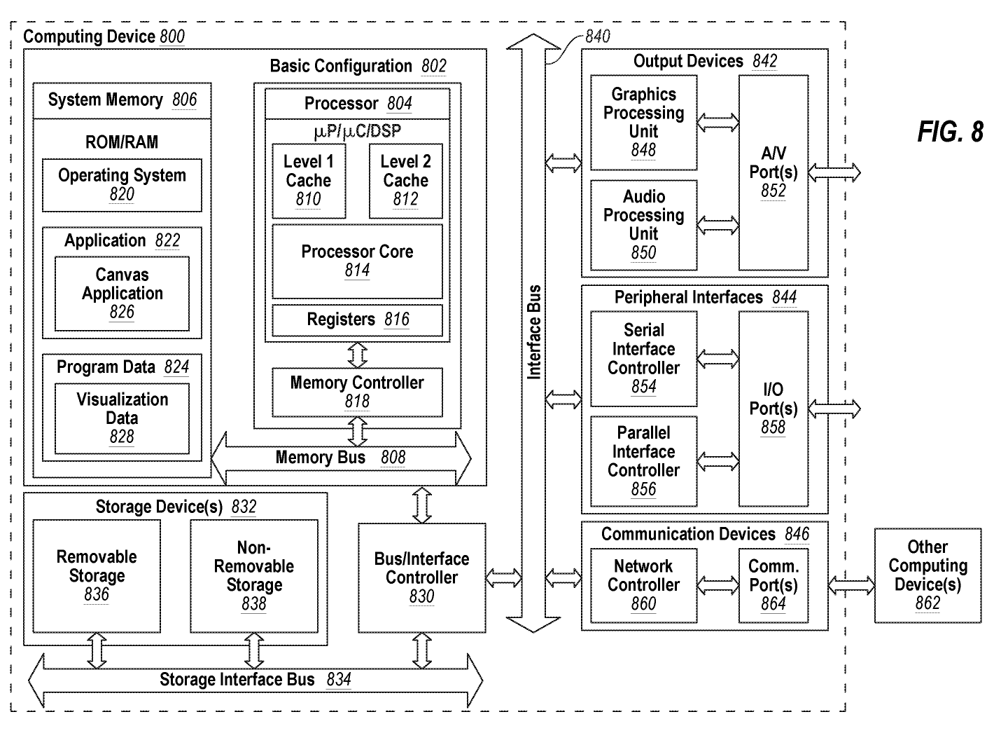

FIG. 8 is a block diagram illustrating an example computing device 800 that is arranged to facilitate selective synchronization between local data, source data, and a visualization and displaying multiple scenarios for a visualization, arranged in accordance with at least one embodiment described herein. The computing device 800 may include, be included in, or otherwise correspond to either or both of the computing device 102 or the server 106 of FIG. 1. In a basic configuration 802, the computing device 800 typically includes one or more processors 804 and a system memory 806. A memory bus 808 may be used to communicate between the processor 804 and the system memory 806.

Depending on the desired configuration, the processor 804 may be of any type including, but not limited to, a microprocessor (µP), a microcontroller (µC), a digital signal processor (DSP), or any combination thereof. The processor 804 may include one or more levels of caching, such as a level one cache 810 and a level two cache 812, a processor core 814, and registers 816. The processor core 814 may include an arithmetic logic unit (ALU), a floating point unit (FPU), a digital signal processing core (DSP Core), or any combination thereof. An example memory controller 818 may also be used with the processor 804, or in some implementations the memory controller 818 may include an internal part of the processor 804.

Depending on the desired configuration, the system memory 806 may be of any type including volatile memory (such as RAM), nonvolatile memory (such as ROM, flash memory, etc.), or any combination thereof. The system memory 806 may include an operating system 820, one or more applications 822, and program data 824. The application 822 may include a canvas application 826 that is arranged to facilitate generation of visualization or multiple scenarios within the visualization. The program data 824 may include visualization data 828 (which may include, be included in, or otherwise correspond to the source data 122, the local data 124, the patch data 107, or some combination thereof of FIG. 1) as is described herein. In some embodiments, the application 822 may be arranged to operate with the program data 824 on the operating system 820 such that one or more methods may be provided as described herein.

The computing device 800 may have additional features or functionality, and additional interfaces to facilitate communications between the basic configuration 802 and any involved devices and interfaces. For example, a bus/interface controller 830 may be used to facilitate communications between the basic configuration 802 and one or more data storage devices 832 via a storage interface bus 834. The data storage devices 832 may be removable storage devices 836, non-removable storage devices 838, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 806, the removable storage devices 836, and the non-removable storage devices 838 (which may include, be included in, or otherwise correspond to one or more of the storage mediums 114 or 118 or the third party data source 104 of FIG. 1) are examples of computer storage media or non-transitory computer-readable media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other non-transitory medium which may be used to store the desired information and which may be accessed by the computing device 800. Any such computer storage media or non-transitory computer-readable media may be part of the computing device 800.

The computing device 800 may also include an interface bus 840 to facilitate communication from various interface devices (e.g., output devices 842, peripheral interfaces 844, and communication devices 846) to the basic configuration 802 via the bus/interface controller 830. The output devices 842 include a graphics processing unit 848 and an audio processing unit 850, which may be configured to communicate to various external devices such as a display (e.g., display 110 of FIG. 1) or speakers via one or more A/V ports 852. The connection list, input data, diagrams, or proxy diagrams generated by the canvas application 826 may be output through the graphics processing unit 848 to such a display. The peripheral interfaces 844 include a serial interface controller 854 or a parallel interface controller 856, which may be configured to communicate with external devices such as input devices (e.g., keyboard, mouse, pen, voice input device, touch input device, etc.), sensors, or other peripheral devices (e.g., printer, scanner, etc.) via one or more I/O ports 858. Such input devices may be operated by a user to provide input to the canvas application 826, which may be effective to generate, modify, or otherwise interact with visual representations and/or charts within the canvas application 826. The communication devices 846 include a network controller 860, which may be arranged to facilitate communications with one or more other computing devices 862 over a network communication link via one or more communication ports 864.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 800 may be implemented as a portion of a small-form factor portable (or mobile) electronic device such as a smartphone, a personal data assistant (PDA) or an application-specific device. The computing device 800 may also be implemented as a personal computer including tablet computer, laptop computer, and/or non-laptop computer configurations, or a server computer including both rack-mounted server computer and blade server computer configurations.

Embodiments described herein may be implemented using computer-readable media for carrying or having computer-executable instructions or data structures stored thereon. Such computer-readable media may be any available media that may be accessed by a general-purpose or special-purpose computer. By way of example, such computer-readable media may include non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving source data from a third party data source, the source data indicating associations between elements of information;
generating local data based on the source data, the local data indicating the associations between the elements of information and the local data being configured to synchronize with a copy of the source data stored by the third party data source;
displaying a graphical object comprising content arranged in accordance with the local data;
suspending synchronization between the local data and the copy of the source data stored by the third party data source;
modifying a portion of the content of the graphical object;
generating a patch collection representative of the modifications to the portion of the content of the graphical object;
resuming synchronization between the local data and the copy of the source data stored by the third party data source; and
responsive to the synchronization being resumed:
updating the local data based on the patch collection; and
providing the patch collection to the third party data source so that the third party data source updates the copy of the source data to reflect the modifications to the portion of the content of the graphical object.

2. The method of claim 1, wherein the local data comprises a locally stored representation of the source data.

3. The method of claim 1, wherein the updating the local data based on the patch collection is further responsive to the third party data source successfully updating the copy of the source data.

4. The method of claim 1, wherein the suspending synchronization between the local data and the copy of the source data stored by the third party data source comprises:
preventing the patch collection from being provided to the third party data source; and
preventing modifications to the copy of the source data stored by the third party data source from being received.

5. The method of claim 4, wherein the resuming synchronization between the local data and the copy of the source data stored by the third party data source comprises permitting modifications to the copy of the source data stored by the third party data source to be received.

6. The method of claim 1, wherein the suspending synchronization between the local data and the copy of the source data stored by the third party data source comprises:
preventing the patch collection from being provided to the third party data source; and
permitting modifications to the copy of the source data stored by the third party data source to be received.

7. The method of claim 1, wherein:
the displaying the graphical object comprises displaying a plurality of graphical objects, each graphical object of the plurality of graphical objects comprising content arranged in accordance with the local data;
the modifying the portion of the content of the graphical object comprises modifying the portion of the content of multiple graphical objects of the plurality of graphical objects; and
the patch collection is representative of the modifications to the portions of the content of the multiple graphical objects.

8. A method comprising:
receiving source data from a third party data source, the source data indicating associations between elements of information;
generating local data based on the source data, the local data indicating the associations between the elements of information;
displaying a first graphical object comprising content arranged in accordance with the local data;
displaying a second graphical object comprising content arranged in accordance with the local data;
modifying a portion of the content of the second graphical object;
generating a patch collection representative of the modifications to the portion of the content of the second graphical object; and
updating the first graphical object based on the patch collection.

9. The method of claim 8 comprising selecting the second graphical object as an approved graphical object, wherein the updating the first graphical object based on the patch collection is in response to the second graphical object being selected as the approved graphical object.

10. The method of claim 8, further comprising displaying a third graphical object comprising content arranged in accordance with the local data, wherein:
the second graphical object comprises a first reference key indicating that the second graphical object is associated with the first graphical object; and
the third graphical object comprises a second reference key that is different than the first reference key, the second reference key indicating that the third graphical object is also associated with the first graphical object.

11. The method of claim 8, wherein:
the patch collection comprises a first patch collection; and
the method comprises:
displaying a third graphical object comprising content arranged in accordance with the local data;
modifying a portion of the content of the third graphical object;
generating a second patch collection representative of the modifications to the portion of the content of the third graphical object;
selecting the second graphical object as an approved graphical object; and
responsive to selecting the second graphical object as the approved graphical object, generating flat data that is not connected to the local data based on the second patch collection and the local data.

12. The method of claim 8, further comprising displaying a third graphical object comprising content arranged in accordance with the local data, wherein:
the second graphical object comprises a first reference key indicating that the second graphical object is associated with the first graphical object; and
the third graphical object comprises a second reference key that is different than the first reference key, the second reference key indicating that the third graphical object is associated with the second graphical object.

13. The method of claim 8, wherein the patch collection comprises a first patch collection, the method comprising:
displaying a third graphical object comprising content arranged in accordance with the local data;
modifying a portion of the content of the third graphical object;
generating a second patch collection representative of the modifications to the portion of the content of the third graphical object;
selecting the third graphical object as an approved graphical object; and
updating the second graphical object based on the second patch collection such that the first patch collection reflects the modifications to the third graphical object, wherein the first graphical object is updated based on the first patch collection such that the modifications to the second graphical object and the third graphical object are incorporated into the first graphical object.

14. A method comprising:
receiving source data from a third party data source, the source data indicating associations between elements of information;
generating local data based on the source data, the local data indicating the associations between the elements of information and the local data being configured to synchronize with a copy of the source data stored by the third party data source;
displaying a first graphical object comprising content arranged in accordance with the local data;
suspending synchronization between the local data and the copy of the source data stored by the third party data source;
displaying a second graphical object comprising content arranged in accordance with the local data;
modifying a portion of the content of the second graphical object;
generating a patch collection representative of the modifications to the portion of the content of the second graphical object;
resuming synchronization between the local data and the copy of the source data stored by the third party data source; and
responsive to the synchronization being resumed:
updating the local data based on the patch collection;
updating the first graphical object based on the patch collection; and
providing the patch collection to the third party data source so that the third party data source updates the copy of the source data to reflect the modifications to the portion of the content of the second graphical object.

15. The method of claim 14 comprising:
receiving input indicating the synchronization between the local data and the copy of the source data stored by the third party data source is to be resumed;
determining the first graphical object and the second graphical object have not been selected as an approved graphical object; and
displaying a notification instructing a user to select the first graphical object or the second graphical object as the approved graphical object, wherein the resuming synchronization between the local data and the copy of the source data stored by the third party data source is in response to receiving input effective to select the first graphical object as the approved graphical object.

16. The method of claim 14, wherein the suspending synchronization between the local data and the copy of the source data stored by the third party data source comprises:
preventing the patch collection from being provided to the third party data source; and
preventing modifications to the copy of the source data stored by the third party data source from being received.

17. The method of claim 16, wherein the resuming synchronization between the local data and the copy of the source data stored by the third party data source comprises permitting modifications to the copy of the source data stored by the third party data source to be received.

18. The method of claim 14 further comprising displaying a third graphical object comprising content arranged in accordance with the local data, wherein:
the second graphical object comprises a first reference key indicating that the second graphical object is associated with the first graphical object; and
the third graphical object comprises a second reference key that is different than the first reference key, the second reference key indicating that the third graphical object is associated with the first graphical object.

19. The method of claim 14, wherein:
the patch collection comprises a first patch collection; and
the method comprises:
displaying a third graphical object comprising content arranged in accordance with the local data;
modifying a portion of the content of the third graphical object;
generating a second patch collection representative of the modifications to the portion of the content of the third graphical object;
selecting the second graphical object as an approved graphical object; and
responsive to selecting the second graphical object as the approved graphical object, generating flat data that is not connected to the local data based on the second patch collection and the local data.

20. The method of claim 14, further comprising displaying a third graphical object comprising content arranged in accordance with the local data, wherein:
the second graphical object comprises a first reference key indicating that the second graphical object is associated with the first graphical object; and
the third graphical object comprises a second reference key that is different than the first reference key, the second reference key indicating that the third graphical object is associated with the second graphical object.

21. The method of claim 14, wherein the patch collection comprises a first patch collection, the method comprising:
displaying a third graphical object comprising content arranged in accordance with the local data;
modifying a portion of the content of the third graphical object;
generating a second patch collection representative of the modifications to the portion of the content of the third graphical object;
selecting the third graphical object as an approved graphical object; and
updating the second graphical object based on the second patch collection such that the first patch collection reflects the modifications to the third graphical object, wherein the first graphical object is updated based on the first patch collection such that the modifications to the second graphical object and the third graphical object are incorporated into the first graphical object.
